(19) United States
(12) Patent Application Publication
(10) Pub. No.: US 2008/0062988 A1
(43) Pub. Date: Mar. 13, 2008

(54) Methods, computer program products, and modules for dynamically allocating bandwidth of a subscriber line

(76) Inventor: Brian Daigle, Marietta, GA (US)

Correspondence Address: MYERS BIGEL SIBLEY & SAJOVEC, P.A., P.O. BOX 37428, RALEIGH, NC, 27627, US

(21) Appl. No.: 11/519,744

(22) Filed: Sep. 12, 2006

(51) Int. Cl. H04L 12/56

(52) U.S. Cl. 370/392; 370/401

(57) ABSTRACT

Methods, modules, and computer program products for allocating bandwidth to a subscriber line that carries packet communications between devices networked across a wide area network are disclosed. At a wide area network access module that connects the subscriber line to the wide area network, at least one of the packets in a packet stream are analyzed to identify a type of protocol associated with the analyzed packet that is indicative of a bandwidth of the packet stream. The wide area network access module varies the bandwidth that is allocated to the subscriber line in response to the indicated; bandwidth of the packet stream. Packet communications through the subscriber line are constrained to no more than the allocated bandwidth.

### FIELD OF THE INVENTION

This invention relates to communications networks and, more particularly, to the flow of data packets through a subscriber line from/to a wide area network.

### BACKGROUND OF THE INVENTION

Wide area communication networks are widely used for nationwide and worldwide communication of voice, video, and other data between networked communication devices. Such traffic is increasingly being carried as packets across packet networks, such as the Internet. To access such networks, a user obtains a subscriber line to, for example, the user's premises from a network operator. The user may connect one or more communication devices through a modem to the subscriber line or through a local area network (e.g., via a wireless local area network router) to the subscriber line. The subscriber line connects the communication devices to an access module which, in turn, interfaces the communication devices to a wide area network. The subscriber line may be, for example, a Digital Subscriber Line (DSL), a digital cable (e.g., digital television and data cable), and/or a wireless communication pathway via, for example, a wireless cellular network, a wireless location/wide area network, and/or a satellite communication network.

The subscriber line may be utilized to carry Voice over Internet Protocol (VoIP) telephone calls, video conference calls, IP Television (IPTV), IP interactive gaming, and Internet Web browsing. Such applications can have widely varying packet communication bandwidth characteristics and needs.

Some network operators allocate different levels of bandwidth to subscriber lines based on tiered service plans, and constrain traffic through those subscriber lines to no more than the allocated bandwidths. While some bandwidth levels may be sufficient for some applications, such as Web browsing, they may be not be sufficient to provide an acceptable quality of service for real-time video conference calls, VoIP calls, or IPTV.

### SUMMARY OF THE INVENTION

Some embodiments of the present invention allocate bandwidth to a subscriber line that carries packets for communication between devices that are networked across a wide area network. A wide area network device analyzes at least one of the packets in a packet stream to identify a type of protocol associated with the analyzed packet that is indicative of a bandwidth of the packet stream. The wide area network device varies the level of bandwidth allocated to the subscriber line in response to the indicated bandwidth of the packet stream.

The access module may increase the bandwidth allocated to the subscriber line when at least a portion of a data payload portion of the analyzed packet(s) is encoded using a protocol that is indicative of a high bandwidth packet stream. The access module may attempt to decode the data payload portion of the analyzed packet(s) using a list of video decompression algorithms and/or audio decompression algorithms, and may identify the encoding protocol in response to successfully decoding the data payload portion using a corresponding one of the list of algorithms. The list of algorithms attempted by the access module may include an MPEG algorithm and/or a video conference data compression algorithm.

The access module may identify when the analyzed packet(s) includes a protocol sequence that is indicative of a video conference call, and may increase the bandwidth allocated to the subscriber line based on that indication. For example, the packet(s) may be analyzed to identify when it includes a RTP, UDP, TCP, and/or HTTP sequence that is indicative of setup of a video conference call and/or the communication of video and/or voice through the analyzed packet(s) for an ongoing video conference call.

The access module may identify when the analyzed packet(s) includes a protocol sequence that is indicative of Internet Protocol Television (IPTV) traffic being carried through the analyzed packet(s), and may increase the bandwidth allocated to the subscriber line based on that indication. Alternatively or additionally, the access module may identify when the analyzed packet(s) includes a protocol sequence that is indicative of Voice Over Internet Protocol (VoIP) traffic being carried through the at least one analyzed packet, and may increase the bandwidth allocated to the subscriber line based on that indication.

The access module may identify an originating port number of the analyzed packet(s), and may vary the bandwidth allocated to the subscriber line based on the identified protocol and originating port number both being indicative of a packet stream bandwidth associated with packet stream. The access module may increase the bandwidth in an uplink direction through the subscriber line while maintaining a substantially constant bandwidth allocation for a downlink direction through the subscriber line when the identified protocol is indicative of a high bandwidth packet stream in an uplink direction.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram of systems, modules, methods and/or computer program products in which a wide area network access module dynamically allocates bandwidth to a subscriber line according to some embodiments of the present invention.

FIG. 2 is a block diagram of the access module of FIG. 1 and associated methods for inspecting a packet, allocating bandwidth, and enforcing bandwidth allocation according to some embodiments of the present invention.

FIG. 3 is a flowchart of methods and associated operations that may be carried out by the packet inspection module to identify when a packet is associated with a protocol that is indicative of a high bandwidth packet stream according to some embodiments of the present invention.

FIG. 4 is a flowchart of methods and associated operations that may be carried out by the bandwidth allocation unit to increase the bandwidth that is allocated to the subscriber line according to some embodiments of the present invention.

FIG. 5 is a flowchart of methods and associated operations that may be carried out by the bandwidth allocation unit to decrease the allocated bandwidth according to some embodiments of the present invention.

FIG. 6 is a flowchart of methods and associated operations that may be carried out by the billing module to determine a cost to be charged for the additional bandwidth according to some embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element, it can be directly responsive to the other element, or intervening elements may be present. In contrast, when an element is referred to as being “directly responsive” to another elements, there are no intervening elements present. As used herein the term “and/or” includes any and all combinations of one or more of the associated listed items and may be abbreviated as “/”. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The present invention is described below with reference to block diagrams and/or flowchart illustrations of methods, apparatus (systems) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

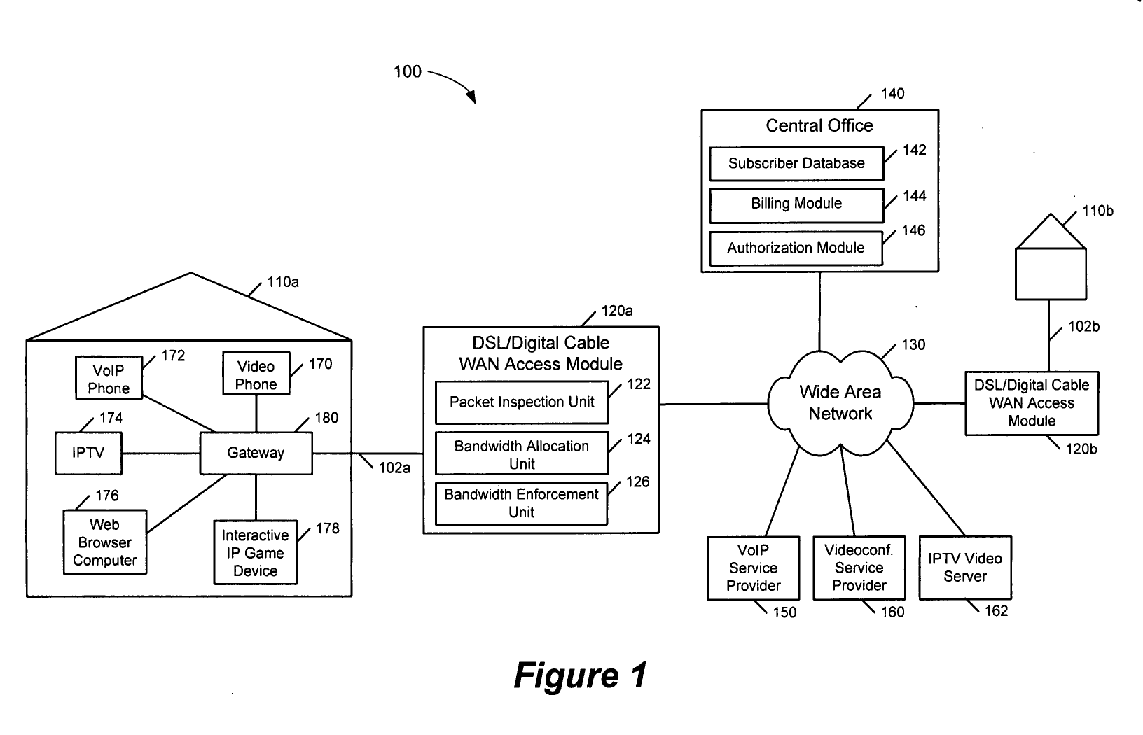

FIG. 1 is a block diagram of systems, modules, methods and/or computer program products, according to some embodiments of the present invention, in which a wide area network access module dynamically allocates bandwidth to a subscriber line based on the module identifying a type of protocol carried by packets which it forwards to/receives from a wide area network. As shown in FIG. 1, a communication system 100 can include a plurality of subscriber lines 102a-b, customer premises 110a-b (e.g., home, office, business), wide area network access modules 120a-b, a wide area network 130, a Voice Over Internet Protocol (VoIP) service provider 150, a videoconference service provider 160, and an IPTV video server 162.

The customer premises 110a can include a plurality of end user communication devices, such as, for example, a video phone 170, a VoIP phone 172, an IPTV 174, a web browser hosted on a computer 176, and an interactive IP game device 178, each of which may be connected through a gateway 180 to an end of the subscriber line 102a. The gateway 180 may be a Local Area Network (LAN) router, such as a wireless LAN (e.g., 802.11b-g), that aggregates signals from the end user devices 170-178 and communicates packetized data through a digital modem, such as a Digital Subscriber Line (DSL) modem and/or a digital cable modem, onto the subscriber line 102a. The subscriber line 102a may be connected through the wide area network access module 120a to the wide area network 130. The access module 120a may be a DSL Access Multiplexer (DSLAM) device and/or a digital cable line access module that may reside as part of a digital loop carrier that aggregates signals from one or more customer premises on a high-speed communications backbone line of the wide area network 130. The customer premises 110b may contain the same type of communication devices (e.g., 170-180) as were described for customer premises 110a, and which are connected to a subscriber line 102b to the access module 120b. The access module 120b may be configured the same as the access module 120a. The wide area network 130 may include the Internet and/or other packet switched networks, and may include a combination of one or more wired and/or wireless packet switched networks.

As is known to those having skill in the art, the video phone 170 may be configured to convert video and voice into digital packets which it communicates through the wide area network 130 to another video phone (e.g., a video phone in premises 110b) either directly or indirectly through the videoconference service provider 160. The video phone 170 may initially setup a videoconference call through the videoconference service provider 160 and, once connected to another video phone through the wide area network 130, may then communicate packetized video and voice directly to the other video phone without routing the packets through the videoconference service provider 160. The video phone 170 may be embodied using a specialized video phone device and/or a hardware/software module hosted on a general purpose computer.

The VoIP phone 172 may be configured to convert voice into digital packets which it communicates through the wide area network 130 to another VoIP phone (e.g., a VoIP phone in premises 110b) either directly or indirectly through the VoIP service provider 150. The VoIP service provider can convert digital VoIP packets into analog signals which can be communicated through a Public Switched Telephone Network (PSTN) to a conventional analog phone. Accordingly, the VoIP phone 172 may be embodied using an analog telephone adapter, a specialized IP phone and/or a hardware/software module hosted on a general purpose computer.

The IPTV 174 may be configured as an interactive on-demand TV through which a user can select among a plurality of TV programs hosted on the IPTV video server 162 to be played through the IPTV 174. The user may provide interactive feedback (e.g., user responses during a televised game show) to the IPTV video server 162 and/or another networked device. Accordingly, the IPTV 174 can cause high-bandwidth audio-video data streams to be communicated from the IPTV video server 162 to the IPTV 174. The interactive IP game device 178 may be configured as a software module hosted on a general purpose computer and/or as a specialized gaming device that shares data and/or program instructions with other interactive IP game devices and/or with a game server.

The video phone 170, the VoIP phone 172, the IPTV 174, the web browser computer 176, and the interactive IP game device 178 can have significantly different packet data communication bandwidth characteristics and needs. For example, the video phone 170 and the IPTV 174 may transmit/receive real-time high-bandwidth packetized video streams through the subscriber line 102a. In contrast, the VoIP phone may transmit/receive lower-bandwidth real-time packetized voice streams through the subscriber line 102a. The Web browser computer 176 and the interactive IP game device 178 may transmit/receive yet lower-bandwidth packetized data through the subscriber line 102a.

Accordingly, an Internet service provider may allocate through the central office 140 a high-bandwidth level to the subscriber line 102a that should be sufficient to support the end user devices having the highest expected bandwidth characteristics, such as video phone calls and IPTV. However, even that bandwidth may not be sufficient when two or more of the end user devices 170-178 operate simultaneously such that they compete for the finite bandwidth allocated to the subscriber line 102a. Moreover, some subscribers may have only an occasional need for high-bandwidth packet communications, and may desire a lower cost service with a lower bandwidth allocation for most communications. A service provider may therefore offer different tiers of bandwidth service at different subscription costs. It may also be desirable for the service provider to allow the bandwidth that is allocated to the subscriber line 102a to be dynamically varied so that, for example, the bandwidth may be temporarily increased to support higher-bandwidth needs of some end user devices (e.g., the video phone 170 and/or IPTV 174) and/or simultaneous use of several end user devices. The service provider may track and charge a premium for the instances of when increased bandwidth is allocated to the subscriber line 102a. The central office may include a subscriber database 142 that may identify subscribers and their allowable bandwidth, a billing module 144 that may track charges for additional bandwidth utilization, and an authorization module 146 that may authorize the allocation of additional bandwidth to subscriber line.

In accordance with some embodiments of the present invention, the access module 120a may be configured to identify a type of protocol that is associated with packets that flow through the subscriber line 102a, and to vary the bandwidth that it allocates to the subscriber line 102a in response to the identified type of protocol. The access module 120a may be further configured to constrain packet communications through the subscriber line 102a to no more than the allocated bandwidth. The access module 120a may thereby dynamically identify when packets from the gateway 180 are indicative of a high bandwidth packet stream(s) between one or more of the end user devices 170-178 and the wide area network 130, and may vary the bandwidth allocated to the subscriber line 102a responsive to that identification. Accordingly, the decision for when to vary bandwidth allocation and the operations for dynamically allocating bandwidth to the subscriber line 102a may at least partially be carried out by the access module 120a, and may be carried out partially, or wholly, autonomously from the central office 140. The access module 120a may thereby automatically identify and respond to a need for higher/lower bandwidth allocation for peer-to-peer communications that can occur directly between two end user devices, such as between two video phones in customer premises 110a and 110b, and which may not flow through the central office 140.

The access module 120a may include a packet inspection unit 122, a bandwidth allocation unit 124, and a bandwidth enforcement unit 126, which may be embodied at least partially within, for example, software executed by digital processing device(s), discrete logic device(s), and/or analog hardware device(s).

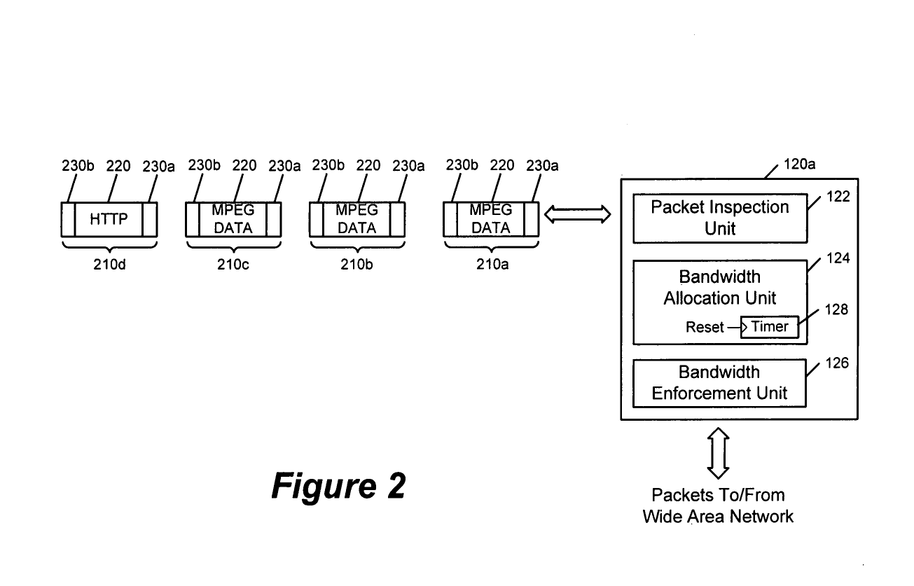

FIG. 2 illustrates an embodiment of the access module 120a. Referring now to FIGS. 1 and 2, the access module 120a receives a stream of packets 210a-d on the subscriber line 102a and forwards the packets to the wide area network 130. The access module 120a similarly receives packets from the wide area network 130 which it forwards to the subscriber line 102a. The packets 210a-d include a data payload portion 220 and a control portion 230. The control portion 230 may include a header portion 230a that occurs at or near the beginning of a packet and/or a trailer or footer portion 230b that occurs at or near the end of a packet.

As described herein, the term “payload portion” is used to generally refer to end user device data carried by a packet, such as voice and/or video data carried from/to the Video phone 170, the VoIP phone 172, and/or the IPTV 174. The term “control portion” is used to generally refer to an overhead portion of a packet and may include routing labels, such as the source and destination addresses, which are used to route packets through the wide area network 130, and/or may include commands for setup, maintenance, and/or termination of a packet switched connection through the wide area network 130 (e.g., commands for a Session Initiation Protocol).

With continuing reference to FIGS. 1 and 2, the packet inspection unit 122 analyzes packets that it receives from, and/or forwards to, the subscriber line 102a to identify a protocol associated with the packets, such a protocol that is indicative of the packets being part of a high bandwidth packet stream. For example, the packet inspection unit 122 may analyze the data payload portion 220 of a packet to identify if it is encoded using a video compression protocol, audio compression protocol, and/or data compression protocol that is indicative of a high bandwidth packet stream. The packet inspection unit 122 may identify a protocol that was used to encode the data payload 220 by attempting to decode at least a portion of the data payload 220 using a list of video decompression algorithms and/or audio decompression algorithms to identify whether the data payload 220 can be successfully decoded therewith. The encoding protocol can then be identified based on which, if any, of the decompression algorithms were successful in decoding the data payload 220. The packet inspection unit 122 may alternatively, or additionally, analyze the data payload 220 and/or control portion 230 to identify a protocol sequence which is indicative of the packet being part of a high bandwidth packet stream, such as a protocol sequence used to setup and/or maintain a video conference call.

For example, the video phone 170 may embed a protocol sequence (e.g., Real-Time Protocol (RTP), User Datagram Protocol (UDP), TCP, and/or HTTP) in the data payload 220 and/or control portion 230 of one or more packets sent to the video conference service provider 160 to request setup of a video conference call to another identified video phone. Once the video conference call is established, further video and voice traffic communications may then occur as peer-to-peer communications between the video phone 170 and other video phone without communication through the video conference service provider 160. Because the access module 120a receives and forwards packets during the call setup and subsequent peer-to-peer traffic communications, it may identify, such as through an analysis of the protocol sequence embedded in the packets and/or the type of compression algorithm used to encode the packet data, when the packets are associated with a high bandwidth packet stream.

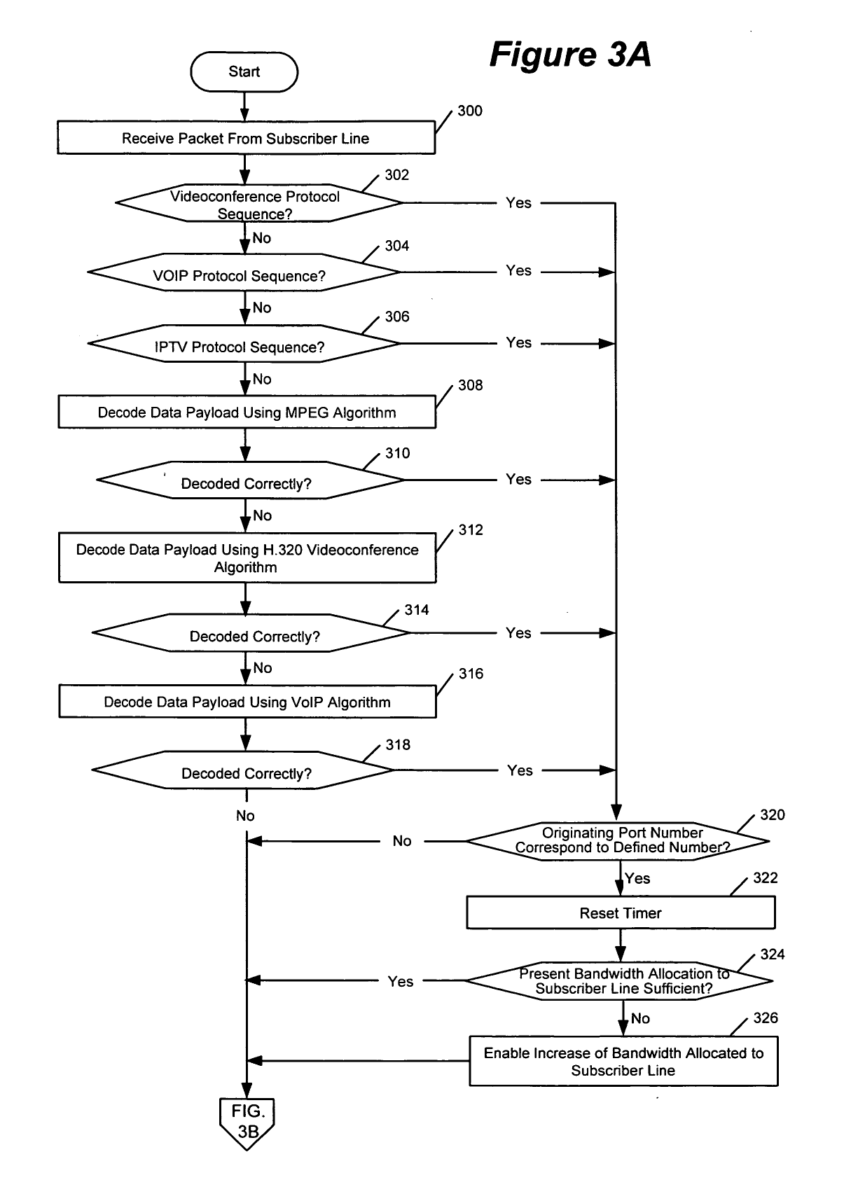

In response to the packet inspection unit 122 identifying that a packet is associated with high bandwidth packet stream, the bandwidth allocation unit 124 may increase the bandwidth allocated to the subscriber line 102a. The bandwidth enforcement unit 126 may function to constrain communications through the subscriber line 102a to no more than the allocated bandwidth. Accordingly, the packet inspection unit 122 can determine when one or more of end user devices 170-178 may need higher bandwidth allocated to the subscriber line 102a, and the bandwidth allocation unit 124 may respond thereto by controlling the bandwidth enforcement unit 126 to make more bandwidth available. Exemplary methods and operations of the packet inspection unit 122 and the bandwidth allocation unit 124 are discussed below with regard to FIGS. 3-5.

FIG. 3 is a flowchart of methods and associated operations that may be carried out by the packet inspection module 122 to identify when a packet is associated with a protocol that is indicative of a high bandwidth packet stream, and to enable an increase/decrease of bandwidth allocated to the subscriber line 102a. Referring to FIG. 3, the packet inspection unit 122 receives a packet from the subscriber line 102a (Block 300). In Blocks 302, 304, and 306, the control portion 230 and/or the data payload 220 of the packet is examined to determine whether it contains a videoconference protocol sequence, such as a protocol sequence that is defined by ITU standard H.320, a VoIP protocol sequence, and an IPTV protocol sequence, respectively.

When the packet does not appear to contain one of the defined protocol sequences, further tests are carried out (Blocks 308-318) to attempt to identify a protocol that was used to encode the data payload 220 by attempting to decode at least a portion of the data payload 220 using a list of video decompression algorithms and/or audio decompression algorithms, which can be indicative of a high bandwidth packet sequence, to identify whether the data payload 220 can be successfully decoded therewith. The data payload 220 may be decoded (Block 308) using a MPEG algorithm (e.g., MPEG 2 and/or MPEG 4). A decision may be made (Block 310) as to whether the data was properly decoded, such as when a result of associated error correction codes is lower than a threshold error level. When the data payload 220 is determined to be MPEG encoded, further tests may be carried out to determine whether the data payload contains High Definition (HD) video data, such as HDTV video (e.g., 1080p or 720p), and/or Standard Definition (SD) video data, such as SDTV video. When the data payload 220 is not MPEG encoded, it may be decoded (Block 312) using a videoconference decoding algorithm (e.g., ITU H.320 decoding algorithm), and a decision is made (Block 314) as to whether the data was properly decoded. When the data payload 220 is not encoded for videoconferencing, it may be decoded (Block 316) using a VoIP decoding algorithm (e.g., ITU H.320 decoding algorithm), and a decision is made (Block 318) as to whether the data was properly decoded.

When the packet is determined to contain one of the defined protocol sequences or is encoded with one of the defined algorithms associated with a high bandwidth packet stream, a further test may be carried out to determine whether the port number of the gateway 180, such as a TCP port and/or a user datagram protocol (UDP) port, from which the packet originated corresponds to a port number that may be known to be used for high bandwidth packet streams. If so, a timer 128, which may reside in the bandwidth allocation unit 124, may be reset to defined value. The present bandwidth that is allocated to the subscriber line 102a may be checked (Block 324) to determine whether it is sufficient for the expected bandwidth characteristics and/or needs of the packet stream associated with the packet. When the present bandwidth is not sufficient, the bandwidth allocation unit 124 may be notified (Block 326) that it more bandwidth should be allocated.

The packet may be forwarded (Block 328) to the wide area network 130. A decision is made (Blocks 330 and 334) as to whether conditions for lowering the bandwidth have occurred, such as when the timer 128 has expired (Block 330) or whether the control portion 230 contains a packet stream termination command (Block 334). When one of the bandwidth lowering conditions has occurred (Blocks 330 and 334), the bandwidth allocation unit 124 may be notified (Block 332) that less bandwidth should be allocated.

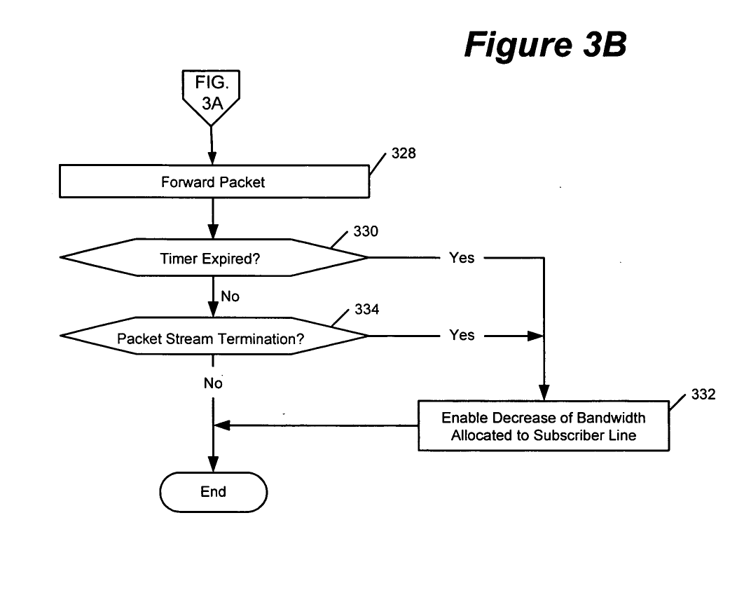

FIG. 4 is a flowchart of methods and associated operations that may be carried out within Block 326 of FIG. 3 by the bandwidth allocation unit 124 to increase the bandwidth that is allocated to the subscriber line 102a. Referring to FIG. 4, a determination is made (Block 400) as to whether additional bandwidth can be allocated to the subscriber line 102a. If so, the central office 140 and/or a user can be queried to obtain authorization for increasing the bandwidth and/or to inform the central office 140 of the opportunity to charge a premium for the additional bandwidth allocation. For example, the bandwidth allocation unit 124 may query the authorization module 146 and subscriber database 142 (Block 402) to confirm that additional bandwidth may be allocated to the subscriber line 102a, and may further determine therefrom how much additional bandwidth is authorized.

When the central office 140 authorizes increased bandwidth (Block 404), a user may be prompted (Block 406) to confirm that the user authorizes an increase in additional bandwidth and the additional costs that may be associated therewith. When the user authorizes increased bandwidth (Block 408), increased bandwidth is allocated to the subscriber line 102a. The level of the increase may be determined based on which protocol sequence and/or encoding algorithm was identified by the packet inspection unit 122. For example, increasingly more bandwidth may be allocated when the packet is associated with higher bandwidth packet streams, such as the following packet streams which sequentially ordered from expected highest to lowest packet bandwidth characteristics: 1) HDTV packet stream; 2) bi-directional SD video conference packet stream; 3) SDTV packet stream; 4) VoIP packet stream; 5) IP interactive gaming data; and 6) Web browsing HTTP packet stream. Moreover, the level of increase may be based on a determination of whether packet streams to two or more end user devices are being carried at the same time through the subscriber line 102a (e.g., overlapping VoIP call and IPTV operation).

The increase in bandwidth may be allocated unequally to uplink communications (from the end user devices 170-178 to the network 130) and downlink communications (from the network 130 to the end user devices 170-178). For example, because some broadband network providers provide a higher baseline downlink bandwidth than uplink bandwidth, the uplink bandwidth may be increased while the downlink bandwidth is maintained substantially constant or may be increased a greater amount than the downlink bandwidth.

At Block 412, the billing module 144 may be notified of the increased bandwidth allocation so that a premium may be charged for the service.

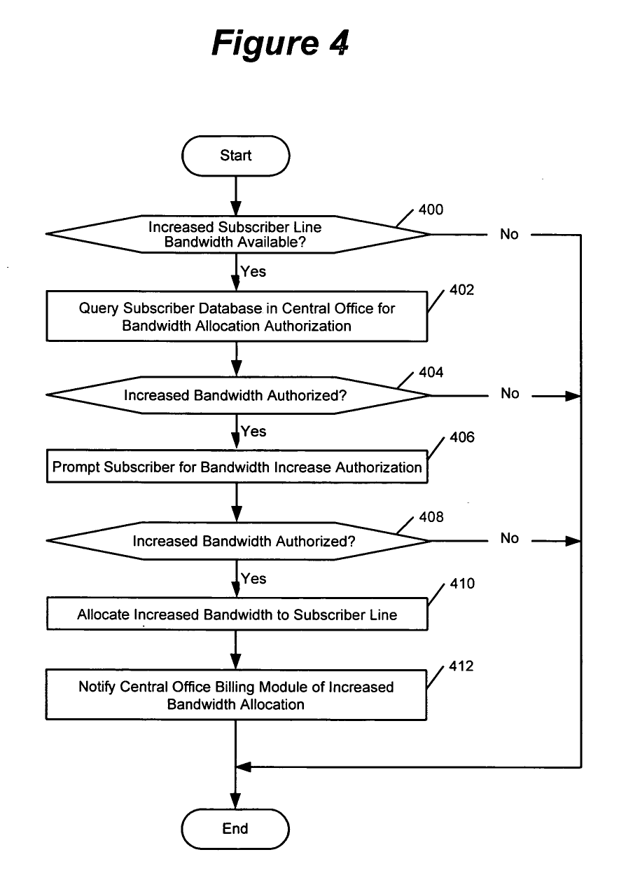

FIG. 5 is a flowchart of methods and associated operations that may be carried out within Block 332 of FIG. 3 by the bandwidth allocation unit 124 to decrease the allocated bandwidth. Accordingly, when the timer is determined to have expired (Block 330 in FIG. 3) or the packet stream is being terminated (Block 334 in FIG. 3), the bandwidth allocated to the subscriber line 102a is compared to a baseline level to determine (Block 500) whether the allocation has been earlier increased above the baseline level. If so, then at Block 502 the allocated bandwidth is decreased, and may be decreased to the baseline level. The billing module 144 of the central office 140 may be notified (Block 504) when the bandwidth allocation is decreased.

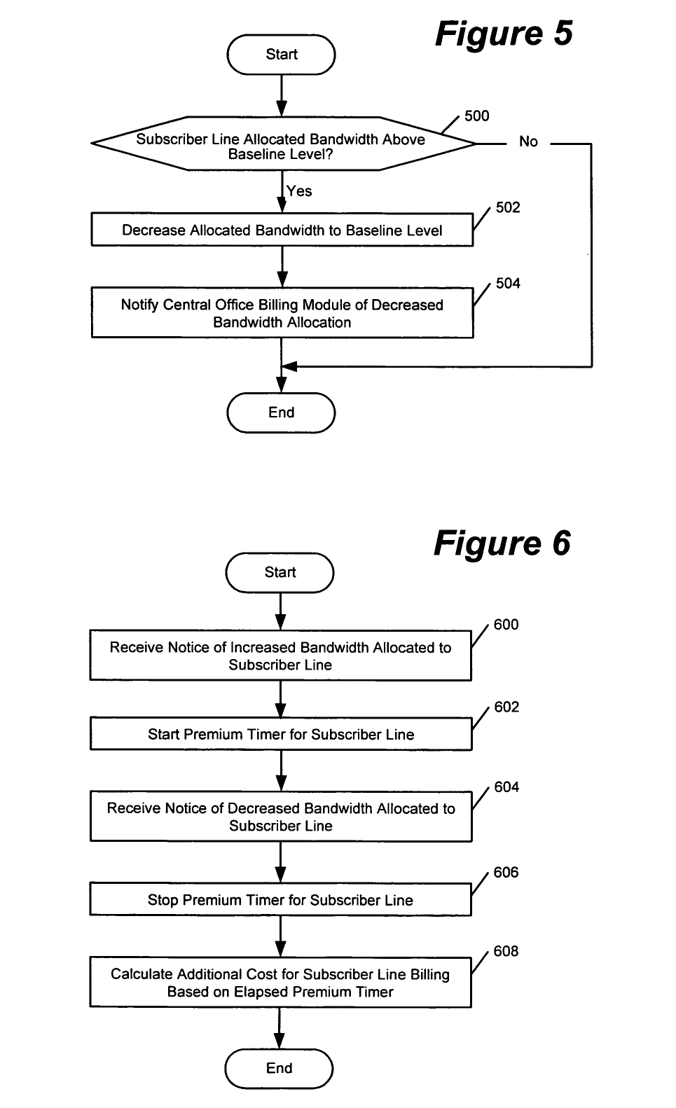

FIG. 6 is a flowchart of methods and associated operations that may be carried out by the billing module 144 to determine a cost to be charged for the additional bandwidth allocated to subscriber line 102a. The billing module 144 receives (Block 600) a notice from the bandwidth allocation unit 124 that increased bandwidth has been allocated to the subscriber line 102a. A timer may be started (Block 602) for tracking the amount of time during the additional bandwidth is allocated. The billing module 144 receives (Block 604) a notice from the bandwidth allocation unit 124 that the allocated bandwidth has been decreased, such as to the baseline level. The timer may be stopped (Block 606) and the cost for the additional bandwidth allocation is calculated (Block 608) based on the elapsed time indicated by the timer. Accordingly, the user will be charged a premium based on how long the additional bandwidth was allocated to the subscriber line 102a.

Accordingly, in some embodiments of the present invention, an access module may identify when one or more packets contain a protocol that is indicative of a high bandwidth packet stream, and may dynamically vary the bandwidth that is allocated to a subscriber line responsive to that identification. In this manner, the decision for when to vary the allocated bandwidth and the operations for dynamically allocating bandwidth to a subscriber line may be at least partially carried out by an access module.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method of allocating bandwidth to a subscriber line that carries packets for communication between devices networked across a wide area network, the method comprising:
analyzing at a wide area network access module, which connects the subscriber line to the wide area network, at least one of the packets in a packet stream to identify a type of protocol associated with the analyzed packet that is indicative of a bandwidth of the packet stream;
varying bandwidth allocated to the subscriber line by the wide area network access module in response to the indicated bandwidth of the packet stream; and
constraining packet communications through the subscriber line to no more than the allocated bandwidth.

2. The method according to claim 1, wherein:
analyzing at a wide area network access module at least one of the packets in a packet stream further comprises identifying an originating port number of the at least one analyzed packet; and
varying bandwidth allocated to the subscriber line comprises varying the bandwidth allocated to the subscriber line based on the identified type of protocol and the identified originating port number both being indicative of a bandwidth of the packet stream.

3. The method according to claim 1, wherein:
analyzing at a wide area network access module at least one of the packets in a packet stream comprises determining when the identified protocol is indicative of a high bandwidth packet stream in an uplink direction through the subscriber line; and
varying bandwidth allocated to the subscriber line comprises increasing the bandwidth allocated to the subscriber line for communications in an uplink direction through the subscriber line while maintaining a substantially constant bandwidth allocation for a downlink direction through the subscriber line based on the identified protocol being indicative of a high bandwidth packet stream.

4. The method according to claim 1, wherein:
analyzing at a wide area network access module at least one of the packets in a packet stream comprises identifying when at least a portion of a data payload portion of the at least one analyzed packet is encoded using a protocol that is indicative of a high bandwidth packet stream; and
varying bandwidth allocated to the subscriber line comprises increasing the bandwidth allocated to the subscriber line based on the identified protocol being indicative of a high bandwidth packet stream.

5. The method according to claim 4, wherein identifying when at least a portion of a data payload portion of the at least one analyzed packet is encoded by a protocol that is indicative of a high bandwidth packet stream comprises:
attempting to decode at least a portion of the data payload portion of the at least one analyzed packet using a list of video decompression algorithms and/or audio decompression algorithms; and
identifying the encoding protocol in response to successfully decoding at least a portion of the data payload portion using a corresponding one of the list of algorithms.

6. The method according to claim 4, further comprising identifying when at least a portion of a data payload portion of the at least one analyzed packet is a video compression algorithm.

7. The method according to claim 6, further comprising identifying when at least a portion of a data payload portion of the at least one analyzed packet is MPEG encoded.

8. The method according to claim 4, further comprising identifying when at least a portion of a data payload portion of the at least one analyzed packet is encoded using a video conference data compression algorithm.

9. The method according to claim 4, wherein varying bandwidth allocated to the subscriber line comprises:
determining when a present bandwidth allocation for the subscriber line is not sufficient for the identified protocol; and
selectively increasing the bandwidth allocated to the subscriber line based on the determination.

10. The method according to claim 4, wherein varying bandwidth allocated to the subscriber line further comprises:
resetting a timer each time at least a portion of a data payload portion of one of the analyzed packets is identified as being encoded using a protocol that is indicative of a high bandwidth packet stream; and
decreasing the bandwidth allocated to the subscriber line in response to expiration of the timer.

11. The method according to claim 4, wherein varying bandwidth allocated to the subscriber line further comprises:
analyzing at least one of the packets to determine when the packet stream is being terminated; and
decreasing the bandwidth allocated to the subscriber line in response to termination of the packet stream.

12. The method according to claim 1, wherein:
analyzing at a wide area network access module at least one of the packets in a packet stream comprises identifying when the at least one analyzed packet includes a protocol sequence that is indicative of a video conference call; and
varying bandwidth allocated to the subscriber line comprises increasing the bandwidth allocated to the subscriber line based on the identified protocol being indicative of a video conference call.

13. The method according to claim 12, wherein identifying when the at least one analyzed packet includes a protocol sequence that is indicative of a video conference call comprises identifying when the at least one analyzed packet includes a RTP, UDP, TCP, and/or HTTP sequence that is indicative of setup of a video conference call.

14. The method according to claim 12, wherein identifying when the at least one analyzed packet includes a protocol sequence that is indicative of a video conference call comprises identifying when at least a portion of a data payload portion of the at least one analyzed packet includes a HTTP sequence that is indicative of communication of video and/or voice through the at least one analyzed packet for an ongoing video conference call.

15. The method according to claim 1, wherein:
analyzing at a wide area network access module at least one of the packets in a packet stream comprises identifying when the at least one analyzed packet includes a protocol sequence that is indicative of Internet Protocol Television (IPTV) traffic being carried through the at least one analyzed packet; and
varying bandwidth allocated to the subscriber line comprises increasing the bandwidth allocated to the subscriber line based on the identified protocol being indicative of IPTV traffic.

16. The method according to claim 1, wherein:
analyzing at a wide area network access module at least one of the packets in a packet stream comprises identifying when the at least one analyzed packet includes a protocol sequence that is indicative of Voice Over Internet Protocol (VoIP) traffic being carried through the at least one analyzed packet; and
varying bandwidth allocated to the subscriber line comprises increasing the bandwidth allocated to the subscriber line based on the identified protocol being indicative of VoIP traffic.

17. The method according to claim 1, further comprising prompting a subscriber in response to the identified type of protocol to authorize an increase in bandwidth, and wherein varying bandwidth allocated to the subscriber line is responsive to the identified type of protocol and authorization from the subscriber to increase bandwidth.

18. The method according to claim 1, further comprising responding to the identified type of protocol by querying a subscriber database within a central office to determine whether the subscriber line is authorized to have increased bandwidth, and wherein varying bandwidth allocated to the subscriber line is responsive to the identified type of protocol and authorization from the central office to increase bandwidth.

19. A computer program product for a local access module, the computer program product comprising a computer usable storage medium having computer-readable program code embodied in the medium, the computer-readable program code configured to perform the method of claim 1.

20. A wide area network access module that is configured to connect a subscriber line to a wide area network and to communicate therebetween packets for communication between networked subscriber devices, the wide area network access module comprising:
a controller that is configured to analyze at least one of the packets in a packet stream to identify a type of protocol associated with the analyzed packet that is indicative of a bandwidth of the packet stream, to allocate bandwidth to the subscriber line in response to the indicated bandwidth of the packet stream, and to constrain data communications through the subscriber line to no more than the allocated bandwidth.
